(19) United States
(12) Patent Application Publication
(10) Pub. No.: US 2011/0087594 A1
(43) Pub. Date: Apr. 14, 2011

(54) DUAL EMERGENCY RESERVE AND SAVINGS ACCOUNT AND SYSTEMS FOR ALLOCATING DEPOSITS

(75) Inventors: Jeffrey H. Bierer, Charlotte, NC (US); Robert M. Mauldin, III, Charlotte, NC (US)

(73) Assignee: BANK OF AMERICA CORPORATION, Charlotte, NC (US)

(21) Appl. No.: 12/897,175

(22) Filed: Oct. 4, 2010

Related U.S. Application Data
(63) Continuation-in-part of application No. 11/839,066, filed on Aug. 15, 2007.

(51) Int. Cl. G06Q 40/00

(52) U.S. Cl. 705/44; 705/39

(57) ABSTRACT

A system and method for providing emergency reserve conditional credit to a customer of a financial institution. The emergency conditional credit may be provided to the customer in the form of a line-of-credit or a loan based on the occurrence of a predetermined condition, such as involuntary unemployment, disability or the like. The emergency reserve product of the present invention is a product that can be offered through a financial institution or other ER-providing entity and, as such, does not require the level of regulation required of an insurance product. The invention also provides for the emergency reserve product to be offered in conjunction with a debt cancellation feature, referred to as emergency reserve protection, which serves to cancel the outstanding debt associated with the loan or line-of-credit.

### REFERENCE TO CO-PENDING APPLICATION FOR PATENT

The present invention is a continuation-in-part of U.S. patent application Ser. No. 11/839,066, entitled, “System and Method for an Emergency Reserve During a Covered Event Using Actuarial Data,” filed on Aug. 15, 2007, assigned to the assignee of the present application, the contents of which are hereby incorporated by reference in their entirety.

### FIELD

In general, embodiments herein disclosed relate to systems, methods, and computer program products for financial investment and, more specifically, providing a dual emergency reserve/savings account that allows for financial institution customers to insure their financial stability in the event of an unforeseen condition, such as loss of employment, disability or the like.

### BACKGROUND

Emergency situations related to loss of income put many people in situations that they are not ready for. A very large percentage of the American population lacks the appropriate resources to deal with an interruption in income. Many within this population do have access to credit, but in many cases that credit is maxed out. A significant portion of that overall subset falls into the low-FICO (Fair Isaac Corporation) credit score/thin credit file/no hit file category which has even fewer reputable, easy to access, non-usurious options for obtaining credit. Many financial institutions' own credit underwriting standards exclude a very large portion of its own population. These financial institutions are only able to extend a pre-approved credit offer to a small percentage of new checking account applicants.

The inability of many people to handle loss of income has been widely published. For example: “[a] one week delay (in pay) would cause 40% of American workers to cut back on critical payments, including rent, mortgage, credit card and utility bills” (Source: ADP Payroll Services Survey); “[n]early one-quarter (22 percent) of U.S. respondents said that once they have covered their basic living expenses, they have no money left over” (Source: ACNielsen Online Consumer Confidence Survey, February 2006); and also almost one-half of all U.S. adults (45%) say their household does not have enough money in liquid savings to cover at least 3 months of living expenses (Source: Harris Interactive nationwide survey of 2,328 adults, February 2006). Most recently a GFK Roper survey of Americans' emergency savings commissioned by Brankrate reported that 54% do not have an emergency savings fund established (Source: Brankrate.com, Jul. 23, 2007).

Customers who do not currently have enough in savings to cover themselves and their families during a period of income interruption are, for the most part, faced with the following options:

TABLE 1

| Option | Average APR | Availability |
|---|---|---|
| Family | NA | Dependent on a number of factors, but in |
| | | most cases family is not a viable option |
| Unsecured | ≧30% | Limited to those who have a good credit |
| Loans | | history and proven means of repayment |
| Pay Day | 300%-500% | Current employment required |
| Lending | | |
| Title Loans | 200%-400% | Must be sole owner of the vehicle |
| Pawn Shops | 100%-200% | availability limited only by the amount |
| | | of pawnable goods the customer owns |
| Credit Cards | ≧34% | Limited to those who have good credit |
| | | and available credit |

Source: Center for Responsible Lending

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present invention provides for a dual emergency reserve/savings account that allows for customers to insure financial stability in the event of an unforeseen condition, such as loss of employment, disability or the like (otherwise referred to herein as a “covered event”). As the customer deposits funds into the dual emergency reserve/savings account, a portion of the deposit is allocated to savings account and another portion to the emergency reserve fee. As the funds available in the savings account increase, the emergency reserve fee will decrease since less reliance will be needed on the emergency reserve in the event of an unforeseen condition (i.e., the funds in the savings account will be used in the event of an unforeseen condition. Thus, the present invention provides for automatically determining the savings account allocation and the emergency reserve fee allocation of a deposit amount. This determination, otherwise referred to as a calibration, takes into account that as the savings account balance increases, the emergency reserve fee will decrease, since less reliance on the emergency reserve will be necessary in the event of a covered event.

Embodiments of the present invention additionally provide for an automated means whereby a customer's future financial needs can be assessed, prior to establishing the dual emergency reserve/savings account, to determine the amount needed in the event of an unforeseen condition (i.e., the amount of the emergency reserve).

A method for establishing a dual emergency reserve/savings account and allocating deposits provides for first embodiments of the invention. The method includes determining a customer's emergency reserve amount based on the customer's perceived financial needs during occurrence of a predetermined covered event. The method further includes establishing, for the customer, a dual emergency reserve/savings account that includes a savings account and an emergency reserve feature, wherein the emergency reserve feature is for the determined customer's emergency reserve amount. The method additionally includes receiving a deposit amount for the dual emergency reserve/savings account, determining, via computing device processor, a savings amount allocation and an emergency reserve fee allocation and depositing, via a computing device processor, the savings amount in the savings account of the dual emergency reserve/savings account and applying the emergency reserve fee to the emergency reserve feature.

In specific embodiments of the method, the customer's emergency reserve amount further includes determining, via a computing device processor, the customer's emergency reserve amount based on one of a plurality of customer models associated with the customer's current financial needs and/or based on customer inputs to a plurality of financial needs queries.

In other specific embodiments of the method, establishing further includes establishing, for the customer, the dual emergency reserve/savings account that includes the emergency reserve feature, such that an initial emergency reserve fee associated with the emergency reserve feature is based on the customer's emergency reserve amount.

In still further specific embodiments of the method, establishing further includes establishing, for the customer, the dual emergency reserve/savings account including the emergency reserve feature, such that the emergency reserve feature is available to the customer in a form of a line-of-credit or a loan.

In additional specific embodiments the method includes determining the deposit amount based on the customer's current financial needs prior to receiving the deposit amount. In such embodiments, determining the deposit amount may further include determining, via computing device processor, the deposit amount based on one of a plurality of customer models associated with the customer's current financial need and/or based on customer inputs to a plurality of financial needs queries.

Moreover, in additional specific embodiments of the method, determining the savings amount allocation and an emergency reserve fee allocation further includes calibrating, via the computing device processor, the savings amount allocation and the emergency reserve fee allocation based on a current savings amount balance in the dual emergency reserve/savings account. In such embodiments of the method, calibrating may further include decreasing the emergency reserve fee allocation based on an increase in the savings amount balance.

Additionally, in further specific embodiments of the method, depositing the savings amount further includes depositing, via the computing device processor, the entire deposit amount in the savings account once a current savings amount balance meets the customer's emergency reserve amount.

Additional specific embodiments of the method include receiving, from the customer, a covered event indication that indicates an occurrence of one of a plurality of covered events. In such embodiments, the method may include providing the customer with a predetermined amount of funds from the emergency reserve feature or access to a predetermined amount of funds from the emergency reserve feature for a predetermined interval. Further, in such embodiments, providing the customer with the predetermined funds may further include providing the customer with a predetermined amount of funds from the emergency reserve feature or access to a predetermined amount of funds from the emergency reserve feature for a predetermined interval based on verifying of the occurrence of the covered event and/or verifying a validity of the emergency reserve feature.

An apparatus for establishing dual emergency reserve/savings accounts and allocating deposits to the accounts defines second embodiments of the invention. The apparatus includes a computing platform including a memory and a processor in communication with the memory. The apparatus further includes a dual emergency reserve/savings account module stored in the memory and executable by the processor. The module includes an emergency reserve amount-determining routine configured to determine a customer's emergency reserve amount based on the customer's perceived financial needs during occurrence of a predetermined covered event. The module further includes a dual emergency reserve/savings establishment configured to establish for the customer, and store in a database, a dual emergency reserve/savings account that includes a savings account and an emergency reserve feature, such that the emergency reserve feature is for the determined customer's emergency reserve amount. In addition, the module includes a deposit allocation routine configured to receive a deposit amount for the dual emergency reserve/savings account, determine for the deposit amount a savings amount allocation and an emergency reserve fee allocation and deposit the savings amount in the savings account and applying the emergency reserve fee to the emergency reserve feature.

In specific embodiments of the apparatus, the emergency reserve amount-determining routine is further configured to determine the customer's emergency reserve amount based on one of a plurality of customer models associated with the customer's current financial needs and/or based on customer inputs to a plurality of financial needs queries.

In other specific embodiments of the apparatus, the dual emergency reserve/savings establishment routine is further configured to establish the dual emergency reserve/savings account that includes the emergency reserve feature, such that an initial emergency reserve fee associated with the emergency reserve feature is based on the customer's emergency reserve amount. In additional embodiments of the apparatus, the dual emergency reserve/savings establishment routine is further configured to establish the dual emergency reserve/savings account including the emergency reserve feature, wherein the emergency reserve feature is available to the customer in a form of a line-of-credit or a loan.

In still further specific embodiments of the apparatus, the dual emergency reserve/savings account module further includes a deposit amount-determining routine configured to determine the deposit amount based on the customer's current financial needs prior to receiving the deposit amount. In such embodiments, the deposit amount-determining routine may be further configured to determine the deposit amount based on one of a plurality of customer models associated with the customer's current financial need and/or based on customer inputs to a plurality of financial needs queries.

Moreover, in further specific embodiments of the apparatus, the deposit allocation routine is further configured to calibrate the savings amount allocation and the emergency reserve fee allocation based on a current savings amount balance in the dual emergency reserve/savings account. In such embodiments, the deposit allocation routine is further configured to decrease the emergency reserve fee allocation based on an increase in the savings amount balance.

In other specific embodiments of the apparatus, the deposit allocation routine is further configured to deposit the entire deposit amount in the savings account once a current savings amount balance meets the customer's emergency reserve amount.

In additional embodiments of the apparatus, the dual emergency reserve/savings account module further includes an emergency reserve fund distribution routine configured to receive, from the customer, a covered event indication that indicates an occurrence of one of a plurality of covered events and provide the customer with a predetermined amount of funds from the emergency reserve feature or access to a predetermined amount of funds from the emergency reserve feature for a predetermined interval. In such embodiments, the emergency reserve distribution routine is further configured to provide the customer with the predetermined amount of funds from the emergency reserve feature or access to the predetermined amount of funds from the emergency reserve feature for a predetermined interval based on verifying of the occurrence of the covered event and/or based on verifying a validity of the emergency reserve feature.

A computer program product including a non-transitory computer-readable medium provides for third embodiments of the invention. The computer-readable medium includes a first set of codes for causing a computer to determine a customer's emergency reserve amount based on the customer's perceived financial needs during occurrence of a predetermined covered event. Additionally, the computer-readable medium includes a second set of codes for causing a computer to establish, for the customer, a dual emergency reserve/savings account that includes a savings account and an emergency reserve feature, such that the emergency reserve feature is for the determined customer's emergency reserve amount. In addition, the computer-readable medium includes a third set of codes for causing a computer to determine, for a received deposit amount, a savings amount allocation and an emergency reserve fee allocation. Moreover, the computer-readable medium includes a fourth set of codes for causing a computer to deposit the savings amount in the savings account of the dual emergency reserve/savings account and apply the emergency reserve fee to the emergency reserve feature.

Thus, embodiments herein described in more detail below provide for establishing dual emergency reserve/savings accounts and, specifically, automatically calibrating the apportionment of deposits between the savings account and the emergency reserve fee. The dual emergency reserve/savings account allows the customer to save funds in the event of an unforeseen condition, such as loss of employment, disability or the like, while providing the additional benefit of an emergency reserve feature, in the event that the savings account has yet to accumulate the funds necessary to support the customer in the event of the unforeseen condition.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a block diagram of an apparatus configured for providing dual emergency reserve/savings accounts and allocating deposits, in accordance with embodiments of the present invention;

FIG. 2 is a more detailed block diagram of an apparatus configured for providing dual emergency reserve/savings accounts, allocating deposits, in accordance with embodiments of the present invention;

FIG. 3 is a flow diagram of a method for providing emergency reserve/savings accounts and allocating deposits, in accordance with embodiments of the present invention;

FIG. 4 is a system for providing emergency conditional credit according to an example embodiment of the present invention;

FIG. 5 is a flowchart of a process for an emergency reserve request and disbursement according to an example embodiment of the present invention;

FIG. 6 is a flowchart of an emergency reserve credit underwriting and sales process according to an example embodiment of the present invention;

FIG. 7 is a flowchart of an ER and ERP enrollment and fulfillment process according to an example embodiment of the present invention;

FIG. 8 is a flowchart of an emergency reserve initial credit disbursement request process according to an example embodiment of the present invention;

FIG. 9 is a flowchart for a continuing ER credit disbursement process according to an example embodiment of the present invention;

FIG. 10 is a flowchart of a process for an emergency reserve at a banking center according to an example embodiment of the present invention;

FIG. 11 is a flowchart of an enterprise pre-approval portion of the passive process of FIG. 10 according to an example embodiment of the present invention;

FIG. 12 is a flowchart of a further portion of the active emergency reserve application process of FIG. 10 according to an example embodiment of the present invention;

FIG. 13 is a flowchart of an emergency reserve sales fulfillment process according to an example embodiment of the present invention; and

FIG. 14 is a flowchart of an emergency reserve banking center and maintenance process according to an example embodiment of the present invention.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution. As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Present embodiments of the invention provide for a dual emergency reserve savings account that allow for a financial institution customer to save for an emergency situation, otherwise referred to herein as a covered event, and to provide for an emergency reserve in the event that the savings account has yet to accumulate the amount needed once the emergency situation occurs. Specifically, embodiments of the present invention provide for automatically determining the apportionment of a deposit amount between the savings account and the emergency reserve fee. As the amount in the savings account increases less reliance on the emergency reserve portion of the account is necessary, as such the emergency reserve fee decreases as the savings account increases. Additionally, embodiments provide for automatically determining the amount of emergency reserve based on the customer's perceived needs in the event of an emergency situation/covered event.

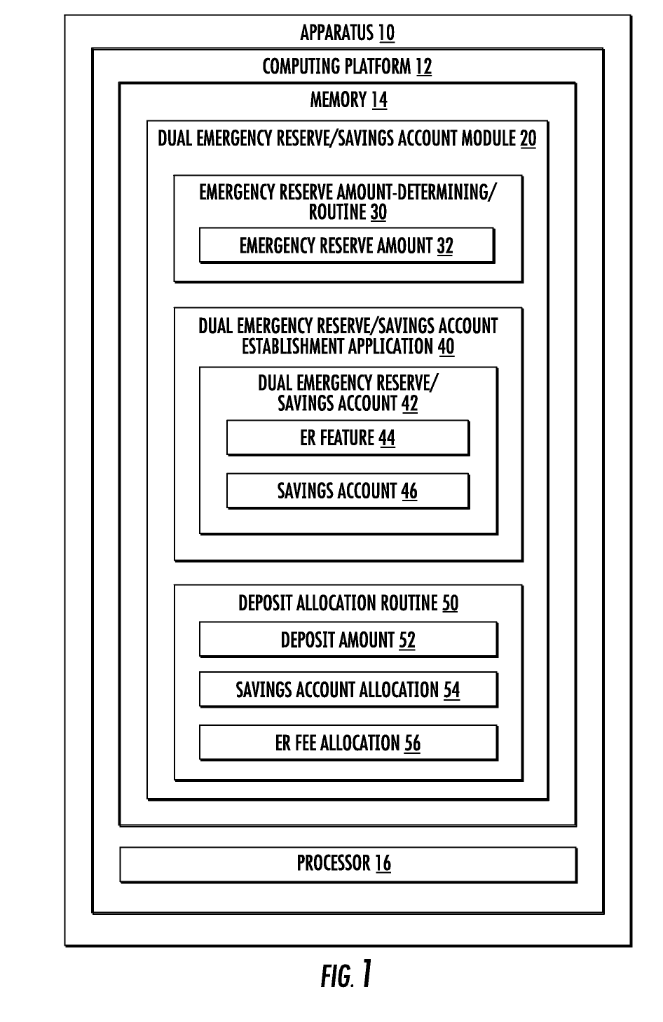

FIG. 1 is a block diagram of an apparatus 10 configured to provide and manage a dual emergency reserve/savings account, in accordance with embodiments of the present invention. The apparatus includes a computing platform 12 having a memory 14 and a processor 16 in communication with the memory. The apparatus additionally includes dual emergency reserve/savings account module 20 stored in the memory 14 and executable by the processor 16.

The dual emergency reserve/savings account module 20 includes an emergency reserve amount-determining routine 30 that is configured to determine the a customer's emergency reserve amount 32 based on the customer's perceived financial needs during occurrence of a predetermined covered event (i.e., an emergency situation deemed “covered” by the financial institution, e.g., involuntary loss of employment, temporary disability or the like). In accordance with specific embodiments of the invention, the emergency reserve amount determining routine 30 is configured to determine the customer's emergency reserve amount 32 based on one or more of a plurality of customer models associated with the customer's current financial status, demographics or the like. In additional specific embodiments, the emergency reserve amount-determining routine 30 is configured to determine the customer's emergency reserve amount based on customer provided answers to a plurality of financial needs queries. The answers to the queries are subsequently applied to one or more of the customer models to determine the customer's emergency reserve needs.

The emergency reserve amount 32 will dictate the emergency reserve fee initially charged to the customer at the onset of the dual emergency reserve/savings account. In addition the emergency reserve amount 32 establishes the savings amount at which the emergency reserve is no longer necessary. For example, if the emergency reserve amount is set at five thousand dollars ($5,000), once the savings account has accumulated $5,000 there is no longer a need for the emergency reserve since the deposits in the savings account can be used by the customer in the event of an emergency situation/covered event. (If the customer has yet to accumulate $5,000 in the savings account and a covered event occurs, the emergency reserve feature of the dual emergency reserve/savings account is used to provide for the amount in which the savings account is deficient the $5,000.) Thus, once the savings account of the dual emergency reserve/savings account has accumulated the emergency reserve amount, the emergency reserve fee is no longer charged to the dual emergency reserve/savings account and, thus the entirety of any deposit amounts are deposited in the savings account.

The dual emergency reserve/savings account module 20 additionally includes a dual emergency reserve/savings account establishment application 40 configured to establish for the customer a dual emergency reserve/savings account 42 having an emergency reserve feature 44 and a savings account 46. The emergency reserve 44 feature is in the determined emergency reserve amount 32. Once the dual emergency reserve/savings account has been established it is stored in a corresponding financial institution emergency reserve/savings account database (not shown in FIG. 1) and the customer may begin making deposits into the savings account 46 and providing the applicable emergency reserve fee.

The dual emergency reserve/savings account routine 50 additionally includes a deposit allocation routine 50 that is configured to receive a customer's deposit amount S2 earmarked for the dual emergency reserve/savings account 42 and determine a savings amount allocation 54 and an emergency reserve fee allocation 56 and deposit the savings amount allocation 54 in the savings account 46 and apply the emergency reserve fee allocation 56 to the emergency reserve feature 44. As previously noted, the emergency reserve feature will be charged a fee associated with the entire determined emergency reserve amount 32 at the onset of the dual emergency reserve/savings account 42 and as the amount in the savings account 46 increases the emergency reserve fee will decrease. Therefore, each time a new deposit amount S2 is received for the dual emergency reserve/savings account the deposit allocation routine 50 performs a calibration to determine the emergency reserve fee (based on the amount currently in the savings account 46 and the deposit amount S2) and to deposit the remainder of the deposit amount S2, absent the determined emergency reserve fee, in the savings account 46. Moreover, as previously discussed, once the savings account meets or exceeds the emergency reserve amount, all deposit amounts S2 are deposited in the savings account 46 portion of the dual emergency reserve/savings account 42.

In addition, as discussed in greater detail infra., once the covered event occurs and is verified by the financial institution, the customer will have access to the emergency reserve funds (if the savings account does not currently provide for the emergency reserve amount or any portion of the emergency reserve amount). The emergency reserve funds may be provided in the form of a loan or a line-of-credit.

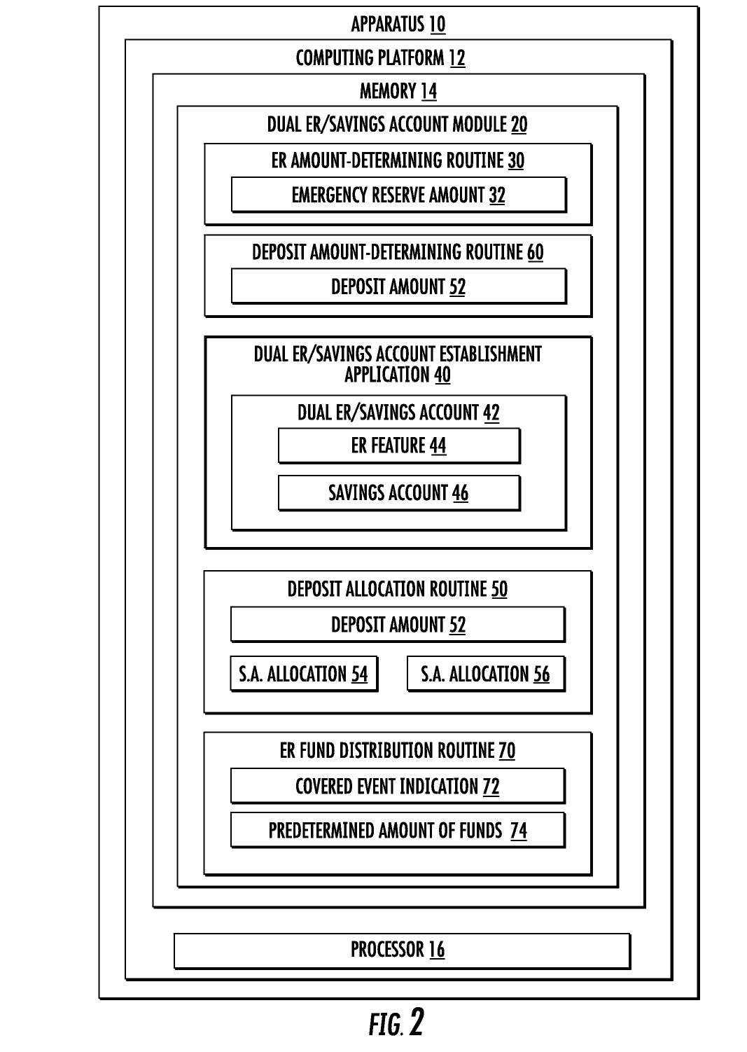

FIG. 2 provides a more detailed block diagram of an apparatus configured for providing and managing dual emergency reserve/savings accounts, including optional embodiments of the present invention. The apparatus 10 may include one or more of any type of computerized device. The present apparatus and methods can accordingly be performed on any form of computing device.

The apparatus 10 includes computing platform 12 that can receive and execute routines and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 2)that interfaces with any resident programs, such as dual emergency reserve/savings module 20 or the like stored in the memory 14 of the apparatus 10.

Processor 16 may include various processing subsystems (not shown in FIG. 2) embodied in hardware, firmware, software, and combinations thereof, that enable the functionality of apparatus 10 and the operability of the apparatus on a network. For example, processing subsystems 42 allow for initiating and maintaining communications and exchanging data with other networked devices. For the disclosed aspects, processing subsystems of processor 16 may include any subsystem used in conjunction with dual emergency reserve/savings module 20 or sub-routines, sub-modules thereof.

The memory 14 of apparatus 10 stores previously described dual emergency reserve/savings account module 20 configured to provide and manage dual emergency reserve/savings accounts, in accordance with embodiments of the present invention.

As previously described, the dual emergency reserve/savings account module 20 includes emergency reserve amount-determining routine 30 configured to determine a customer's emergency reserve amount 32 based on perceived customer financial needs during occurrence of a covered event/emergency situation. In addition, the dual emergency reserve/savings account module 20 may include deposit amount-determining routine 60 that is configured to determine a deposit amount S2 (i.e., a savings amount) for the customer to contribute to the dual emergency reserve/savings account on a continual ongoing basis, such as monthly or the like. The deposit amount S2 may be based on the customer's current financial status, including current financial needs and current income and the determined emergency reserve amount 32. In specific embodiments the deposit amount S2 may be determined based on one or more of a plurality of customer models and/or customer provided answers to financial need/current income queries. It should be noted that the deposit amount S2 is a suggested savings amount and that in practice the actual savings amount may vary from period to period (e.g., month-to-month) based on actual customer finances and the like.

As additionally discussed previously, the dual emergency reserve/savings account module 20 includes dual emergency reserve account establishment application 40 that is configured to establish the dual emergency reserve/savings account 42 based on the emergency reserve amount 32 and, in certain embodiments, after determination of the savings amount 62. In addition, as previously discussed, the dual emergency reserve/savings account includes deposit allocation routine 50 that is configured to receive a customer's deposit amount S2, which may be the customer's determined deposit amount S2, earmarked for the dual emergency reserve/savings account 42, determine a savings amount allocation 54 and an emergency reserve fee allocation 56, deposit the savings amount allocation 54 in the savings account 46 and apply the emergency reserve fee allocation 56 to the emergency reserve feature 44. Each time a new deposit amount S2, which may be customer's determined deposit amount S2, is received for the dual emergency reserve/savings account the deposit allocation routine 50 performs a calibration to determine the emergency reserve fee and to deposit the remainder of the deposit amount S2, absent the determined emergency reserve fee, in the savings account 46.

Additional optional embodiments of the apparatus 10, the dual emergency account module 20 includes emergency fund distribution routine 70 that is configured to receive, from the customer. A covered event indication 72 that indicates the occurrence of one of the plurality of covered events and provide the customer with a predetermined amount of funds from the emergency reserve feature 44 or access to a predetermined amount of funds from the emergency reserve feature for a predetermined interval, such as a month or the like. In specific embodiments of the invention, the predetermined amount of funds 74 accessible to a customer during a predetermined interval is a portion of the overall emergency reserve amount 32, such that predetermined amount of funds accessible to the customer has a maximum limit during the predetermined interval, which is less than the overall emergency reserve amount. For example, if the emergency reserve amount is $5,000, the predetermined amount of funds 74 may be approximately $800 for each predetermined interval, e.g., month that the covered event continues to exist in, up to a maximum of six predetermined intervals in which the predetermined amount is accessed or distributed. Additionally, the predetermined amount of funds 74 may take into account the amount currently in the savings account 46 portion of the dual emergency reserve/savings account 42. Thus, for example, if the savings account has a balance of $2,000 and the emergency reserve amount is $5000, the predetermined amount of funds 74 may be $500 for each pre-determined interval, e.g., month that the covered event continues to exist in, up to a maximum of six predetermined intervals in which the predetermined amount is accessed or distributed. This is because the savings account balance of $2,000 is used to offset the emergency reserve amount of $5,000.

In addition, the emergency fund distribution routine 70 may be further configured to distribute or provide access to the predetermined amount of funds 74 based on verification of the occurrence of the covered event an/or verification of the validity of the emergency reserve feature. The validity of the emergency reserve feature may be based on funds being available in the emergency reserve feature and/or payment of the emergency reserve fee being up-to-date.

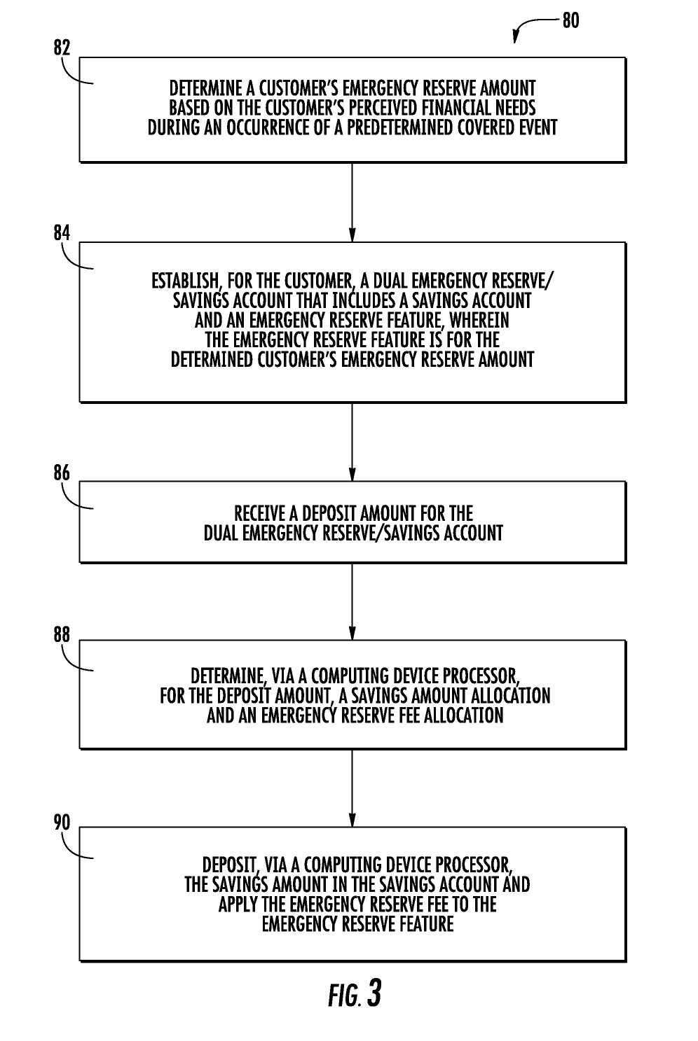

Referring to FIG. 3 a flow diagram is presented of a method 80 for providing and managing a dual emergency reserve/savings account, in accordance with embodiments of the present invention. At Event 82, a customer's emergency reserve amount is determined based on the customer's perceived financial needs during an occurrence of a predetermined covered event (i.e., emergency situation, such as involuntary job loss, temporary disability or the like). In specific embodiments of the method, determining the customer's emergency reserve amount may be further based on one or more of a plurality of customer models and/or customer provided responses to a plurality of financial needs queries.

At Event 84, a dual emergency reserve/savings account is established for the customer. The dual emergency reserve savings account includes an emergency reserve feature and a savings account. The emergency reserve feature for the determined customer's emergency reserve amount. In specific embodiments of the invention, funds associated with the emergency reserve feature are available to the customer, upon occurrence of a covered event, in the form of a loan or a line-of-credit. In specific embodiments of the method, the initial emergency reserve fee charged to the emergency reserve feature is based on the customer's emergency reserve amount. As the amount in the savings account grows, less financial reliance on the emergency reserve feature is needed upon occurrence of a covered event and, as such the emergency reserve fee charged to the emergency reserve feature will decrease.

At Event 86, a deposit amount for the dual emergency reserve/savings account is received. The deposit amount may be a recommended deposit amount determined for the customer based on the customer's current financial status, such as financial needs and current income. In such embodiments of the method, the recommended deposit amount may be further determined based on customer models and/or customer responses to a plurality of financial status queries. It should be noted that in those embodiments in which a recommended deposit amount is determined, the actual deposit amount may vary from the recommended deposit amount as the customer deems necessary.

At Event 88, a savings amount allocation and an emergency reserve fee allocation are determined, via a computing device, for the deposit amount. In specific embodiments of the method, the savings amount allocation and the emergency reserve fee allocation are determined based on a current savings amount balance in the dual emergency reserve/savings account. In such embodiments of the method, determining includes calibrating the amount allocated to the savings account and the amount allocated to the emergency reserve fee. As previously noted, as the amount in the savings account increases, the financial reliance on the emergency reserve feature decreases and, as such, the emergency reserve amount and the corresponding emergency reserve fee decrease.

At Event 90, the savings amount is deposited in the savings account and the emergency reserve fee is applied to the emergency reserve feature. In specific embodiments, in which the current savings amount meets or exceeds the determined emergency reserve amount, the entire deposit amount is deposited in the savings account (i.e., no emergency reserve feature is needed and, therefore, no emergency reserve fee is applied because the amount in the savings account satisfies the financial needs in the event of a covered event/emergency situation.

The Emergency Reserve (ER) portion of the dual emergency reserve/savings account is a conditional credit that can be accessed only during a covered event. The covered events may be determined by a particular financial institution. For illustrative purposes, embodiments of the present invention will be described where the covered events are involuntary unemployment, disability, and hospitalization, however, embodiments of the present invention are not limited by these example covered events and includes all types of events that may be determined by a financial institution or entity providing the ER.

In certain embodiments of the invention the conditional credit takes the form of a line-of-credit, while in other embodiments of the invention the conditional credit takes the form of a loan.

The line-of-credit ER embodiments differs from the loan ER embodiments in that the line-of-credit ER can be replenished based on the customer re-paying amounts of the line-of-credit, which they previously accessed. In theory, the fact that line-of-credit ERs can be replenished means that they may exist perpetually, however, in practice, line-of-credit ER's are typically configured with a finite duration, such as up to ten years or the like. Conversely, once the loan ER has been exhausted by the customer, the ability to be provided additional funds ceases to exist, i.e., replenishment is not possible even after repayment of the entire loan amount—the only option for the customer is to re-apply for a new ER.

In addition, because the means by which the Annual Percentage Rate (APR) is calculated for a line-of-credit versus a loan, and to ensure that the APR is not excessive for a loan-like ER, the period of time for which the line of credit is configured to be available is typically longer than the period of time (i.e., the coverage period) for which the loan is available. In certain embodiments of the invention, the line-of-credit ER may be available for approximately three times longer than the loan ER, for example, a line-of-credit ER may be configured to be available to the customer for upwards of ten years, while a loan ER may be configured to available for three years. After the expiration of the loan ER or the line-of-credit ER the customer is required to re-apply for a new ER product. It should be noted that in specific embodiments the APR is used to determine the initial ER fee charged for the loan ER or the line-of-credit ER, as in both instances the loan or the line-of-credit is repaid at a zero interest rate

According to embodiments of the present invention in which the conditional credit takes the form of a line-of-credit, a predetermined line-of credit amount may be provided to a customer based on occurrence and continuation of a predetermined conditional event. In certain embodiments, a specific set amount, as opposed to the total amount of the line-of-credit, is available to the customer on a predetermined interval, such as monthly, as long as the condition that precipitated the line-of-credit being accessible continues. The set line-of-credit amount and the amount available to the client during a predetermined interval are configured by the financial institution or dual ER/savings account-providing entity.

For example, an entity may provide an ER that provides a $6,000 line-of-credit. In practice, the customer initially notifies the dual ER/savings account-providing entity of the occurrence of the covered event and, upon dual ER/savings account-providing entity verification of the conditional event and/or validity of the ER (i.e., up-to-date payment of the ER fees), the customer is provided access to the specific amount set for the first month, e.g. $1,000. Thus, the customer can choose to access the line-of-credit during the first month for up to $1,000. If the covered event is still occurring after the first month, the customer is provided with access to a second specific amount for the second month; e.g., $1,000, and so on. The number of predetermined intervals afforded to the customer will depend upon the condition continuing to exist, the total amount of the line-of-credit and the amount of the line-of credit currently used by the customer. For example, if the ER is configured to provide a $6,000 line-of-credit to the customer and, upon occurrence and continuation of a predetermined condition, the customer accesses $1,000 each month, i.e., the full predetermined amount available for the predetermined interval, the customer is afforded six predetermined intervals, i.e., six months. Unless, the customer is re-paying the line-of-credit during the six months, in which case the line-of-credit is replenished and the amount available to the customer after the six month period will be equivalent to the amount re-paid (if the amount repaid exceeds the specific amount that is accessible for the predetermined period, e.g., the repaid amount is greater than $1,000, the customer will have access up to the specific amount, i.e., $1,000).

In another example of a practical application of the line-of-credit ER, the customer initially notifies the dual ER/savings account-providing entity of the occurrence of the covered event and, upon the dual ER/savings account-providing entity verification of the conditional event and/or validity of the ER, the customer is provided access to a first specific amount for the predetermined interval; e.g., $1,000 for the first month and, if the condition persists into the second interval, the customer is provided access to a second specific amount; e.g., $1,000 for the second month. Assuming that the condition precipitating access to the line-of-credit ER is eliminated during the second interval, the customer will no longer have access to additional funds from the line-of-credit. Additionally, assuming that the customer accessed the full amount available during the periods in which the condition existed, e.g., $2,000 over the two month period, if the customer subsequently repays the $2,000 and then the same or a different condition is determined to subsequently exist in the future, the customer will have access to the full amount of the line-of-credit, since the previously accessed $2,000 has been re-paid.

Absent an Emergency Reserve Protection (ERP) feature (discussed infra.), the customer is required to begin repaying the conditional credit line-of-credit after a predetermined period following a disbursement; for example 90 days after the last disbursement. The line-of-credit ER is required to be re-paid by the customer within a predetermined period of time, for example, within five years or the like.

According to embodiments of the present invention in which the conditional credit takes the form of a loan, a predetermined loan amount may be provided to a customer over a predetermined amount of time based on occurrence and continuation of a predetermined conditional event. The set loan amount and the set amount of time are determined by the financial institution or the dual ER/savings account-providing entity. In other embodiments of the invention, in which the conditional credit takes the form of a loan, the ER may be configured such that certain predetermined events, e.g., marriage, retirement, moving or the like provide for a one-time only disbursement of a predetermined amount. In such instance, the one-time only disbursement may be configured to count toward the overall ER loan balance or, in other embodiments; the one-time only disbursement may be configured to a separate loan/benefit that does not count against the overall ER loan balance.

For example, an entity may provide an ER that provides loan-like benefits of $500/month for up to 6 months; $3,000 total. In practice, the customer initially notifies the dual ER/savings account-providing entity of the occurrence of the covered event and, upon dual ER/savings account-providing entity verification of the conditional event and/or validity of the ER, the customer is provided the first monthly benefit; e.g., $500. If the covered event is still occurring after the first month, the customer is provided with the second monthly benefit; e.g., $500, and so on for up to 6 months.

Absent an Emergency Reserve Protection (ERP) feature (discussed infra.), the customer is required to begin repaying the conditional credit loan after a predetermined period following the last disbursement; for example 90 days after the last of the six monthly $500 disbursements or, in the event that the qualifying condition did not exist for the entire 6 month period, 90 days after the last $500 disbursement. The loan ER is required to be re-paid within a predetermined repayment period, for example, within two years or the like.

In embodiments in which the conditional credit takes the form of a loan, the conditional credit is extended for a predetermined coverage period, for example, a three year coverage period. Once the customer has exhausted the total amount of the ER or the predetermined coverage period has expired the customer is required to re-apply for the emergency reserve product. It should be noted that in those embodiments in which the conditional credit is structured as a loan, unlike those embodiments in which the conditional credit is structured as a line-of-credit, re-applying for the emergency reserve product is required even after the loan has been paid in full.

Moreover, according to embodiments of the present invention and as previously mentioned, the dual ER/savings account-providing entity may provide a customer an option to add an optional debt cancellation protection feature to their Emergency Reserve. For illustrative purposes, this debt cancellation option may be called an Emergency Reserve Protection (ERP). According to specific embodiments, the ERP is offered to the customers at a higher fee than an ER without the ERP feature. The ERP protection would cancel an outstanding ER balance on a monthly basis during a covered event, resulting in the customer not having to repay the balance on the loan or the line-of-credit depending on configuration of the ER. Therefore, should a covered event occur, a customer subscribing to the ER as well as the ERP would, in the case of a loan, receive the disbursement amount for the predetermined interval for as long as the condition exists or, in the case of a line-of credit, access up to the specified amount during the predetermined interval for as long as the condition exists, but would owe nothing at the conclusion of the disbursements. This is advantageous in that a customer who has suffered a loss of income, but has enrolled in these services, gets needed cash immediately without incurring any additional debt.

Both the ER product and the ERP feature would be offered by the financial institution or entity. According to specific embodiments of the invention, the ER and its ERP feature are classified as “banking” or “financial institution” product and, as such, would be subject to Office of the Comptroller of the Currency (OCC) regulation, as opposed to an “insurance” product which would be subject to State Departments of Insurance regulations. As such, the ER product and ERP feature can be offered by non-licensed individuals, as opposed to insurance products, which require sale by licensed insurance agents.

Embodiments of the present invention providing ER and an ERP features are advantageous in that an ER is “conditional credit” that is based on the dual ER/savings account-providing entity's knowledge of actuarial risk. ER being “conditional credit” means that the funds can only be accessed during a covered event. By having the ER-providing entity price or otherwise set the customer's fee for the conditional credit based on a financial institution's significant incidence experience, the financial institution is able to severely mitigate the credit risk. The mitigation of the credit risk allows the ER-providing entity, such as a financial institution to offer an ER product to existing customers, as well as potential new customers, which is advantageous over current lending procedures.

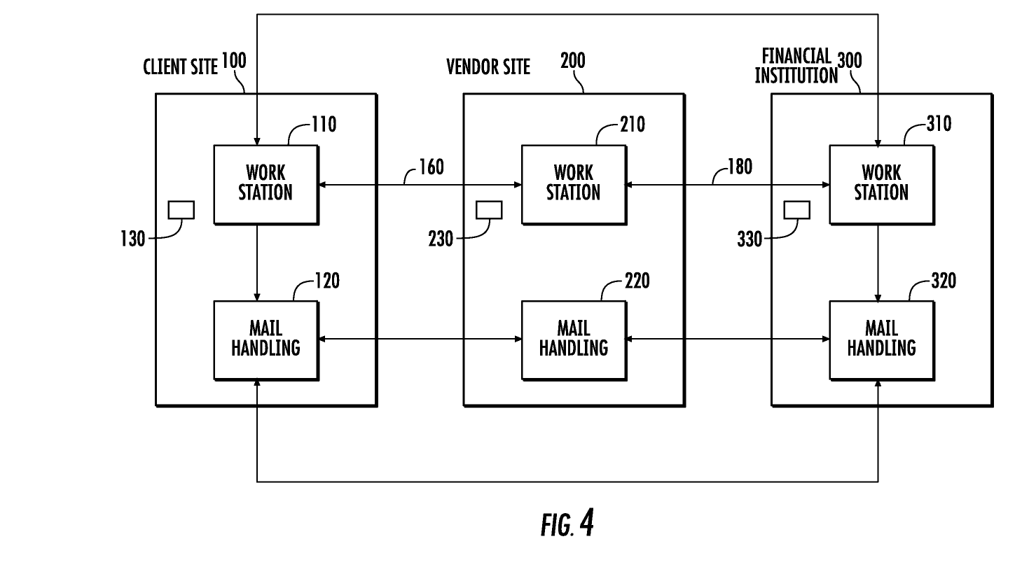

FIG. 4 shows a system for providing emergency conditional credit, such as a dual ER/savings account, according to an example embodiment of the present invention. The system may include a financial institution site 300 that includes a workstation 310 and the capability for sending and receiving mail 320. The system may also include a client site 100 that includes a workstation 110 and the capability to send and receive mail 120. The financial institution 300 may offer the dual ER/savings account and an associated ERP feature to a client at the client site 100 via an electronic communication means 120. The electronic communication means may be a network such as the Internet or any other type of wired or wireless electronic method of communication such as text, emails, etc. The financial institution 300 may offer the dual ER/savings account, send applications and other documents related to the dual ER/Savings account, receive information and other documents from a client, and make benefit disbursements through the electronic communication means. Further, the client site 100, vendor site 200, and financial institution 300 may each have an apparatus 130, 230, 330, respectively, comprising a storage medium that includes instructions stored therein, that when inserted and executed help perform at least some of the processing performed by the client site 100, vendor site 200, and financial institution 300.

Alternatively, the financial institution may send marketing materials, applications and other documentation related to the dual ER/savings account and associated ERP feature via courier or mailing or any other non-electronic method. Similarly, a client at client site 100 having mail handling capability 120 may send completed applications for the dual ER/savings account and associated ERP feature as well as other documentation (e.g., request for emergency reserve), to the financial institution via a courier, regular mail, etc.

Although not shown, if a client at a client site 100 has successfully completed an application for the dual ER/savings account and has been approved, and qualifies for an emergency reserve disbursement, the financial institution 300 may deposit via electronic means a cash payment into a bank or other institution designated by the client.

Moreover, the financial institution 300 may desire that one or more third-parties or vendors 200 serve as an intermediary between a client at client site 100 and the financial institution 300 for performing various tasks related to the dual ER/savings account and the associated ERP feature. For example, a vendor site 200 may include a work station 210 and mail handling capability 220, and may perform any of many various tasks related to the dual ER/savings account and the associated ERP feature. For example, the vendor site 200 may handle the distribution of marketing materials to potential customers, provide applications to potential customers, receive completed applications from people, process the applications, approve or disapprove customer applications, receive requests for emergency reserve payouts, process these requests, approve or disapprove these requests, or verify that customers still qualify for the dual ER/savings account and the associated ERP feature, etc. This may be advantageous to a financial institution 300 in that several tasks may be off-loaded onto one or more vendor sites 200 relieving the financial institution of performing the various processing, marketing, etc. activities related to managing the offering and maintaining of the dual ER/savings account and the associated ERP feature. In this regard, the vendor site 200 may communicate with a client site 100 via an electronic method or network 160 as well as communicate with a financial institution 300 via an electronic communication method or network 180. The vendor site 200 may also provide the various services in a non-electronic way such as via courier, mail, etc.

To illustrate embodiments of the present invention, one or more vendors will be used for handling some of the dual ER/savings account processing between the customer site and the financial institution. Due to the vast amount of processing and other business activities that a financial institution must manage, delegating portions of the handling of the dual ER/savings account and the associated ERP feature may be beneficial in off-loading work from the financial institution that can easily be performed by a vendor(s). However, embodiments of the present invention are not limited by the use of one or more vendors as an intermediary, and any embodiments where a financial institution directly handles the maintenance and processing of a dual ER/savings account and the associated ERP feature are within the scope of the present invention.

Moreover, the use of the term vendor and vendor site in the descriptions of embodiments of the present invention may refer to one vendor or may refer to more than one vendor. Further, the term vendor may represent different types of vendors that perform different tasks or different functions, for example, list processing, forms processing, validation processing, approval/denial processing, credit processing, or any other activity or process that may be performed by some other entity outside of the financial institution and the customer site.

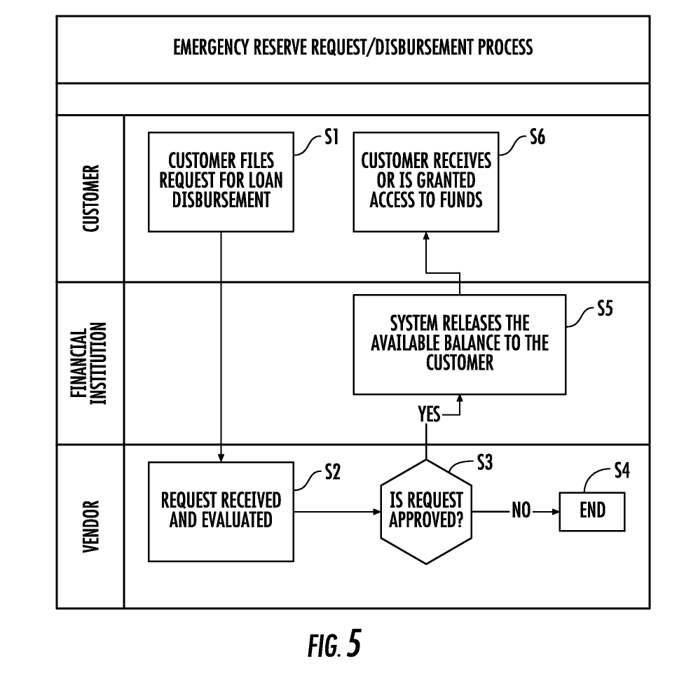

FIG. 5 shows a flowchart of a process for an emergency reserve request and disbursement according from a dual ER/savings account, in accordance with an example embodiment of the present invention. A customer at a customer site files a request for credit disbursement S1. A vendor company 20 receives the credit disbursement request and determines eligibility S2 (i.e., verification of the condition, validity of payment of required fees by the customer, etc.). The vendor determines if the request is approved and, if not, the process ends S4. If the request is approved S3, approval notification is sent to the financial institution 30. The financial institution 30 then, in the loan ER scenario, releases the predetermined cash payment amount for the first interval to the customer S5. Alternatively, the financial institution 30 then, in the line-of-credit scenario, provides the customer with access to the predetermined amount for the first predetermined interval. The customer then receives or gains access to the emergency cash funds S6 and uses them appropriately.

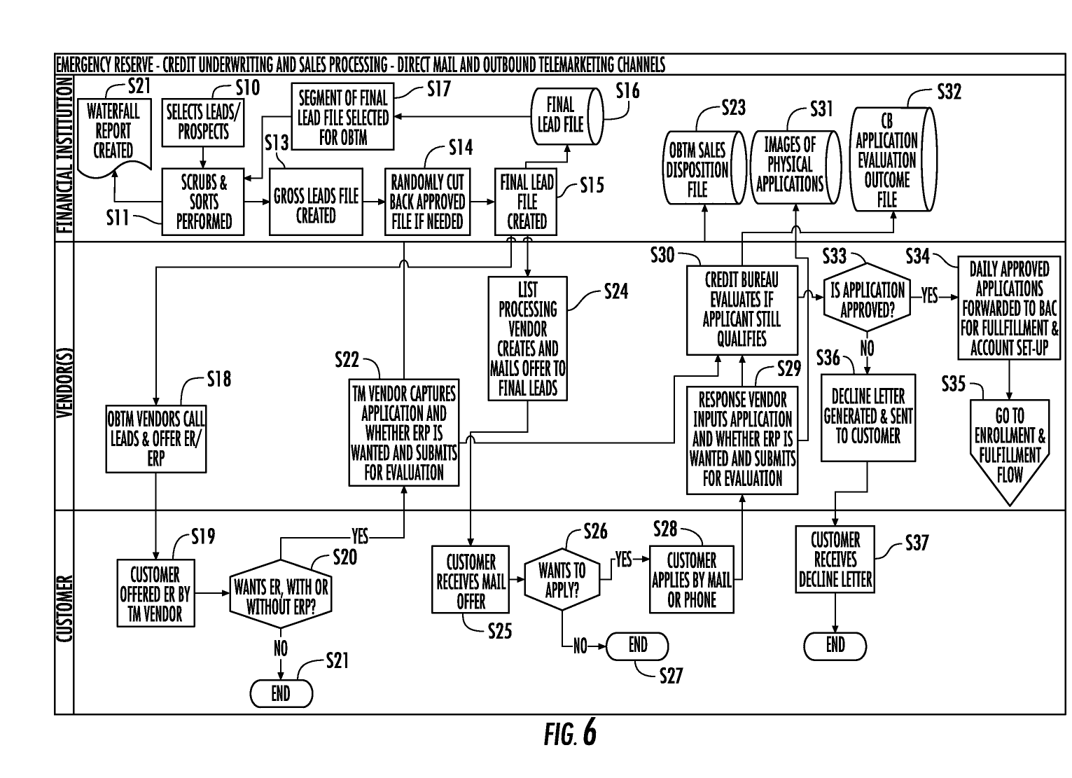

FIG. 6 shows a flowchart of an emergency reserve credit underwriting and sales process according to an example embodiment of the present invention. As illustrated in FIG. 6, different functions and processes may be performed by the financial institution 30, a vendor site 20, and customer site 10. At the financial institution site 30, a marketing center may select leads/prospects for the dual emergency reserve/savings account S10. These leads and/or prospects may be scrubbed and sorted S11. A waterfall report may be created S12. The gross leads after being scrubbed and sorted may be stored in a file S13. The financial institution 30 may have set a maximum number of people to be targeted for marketing and/or offering of the dual ER/savings account. If this is so, the information stored in the file may be further cut in a random or an ordered manner S14. A final lead file may then be created S15 and then stored S16. A segment of the final lead file may be selected for further processing S17. The process may repeat where the segment of the final lead file selected again undergoes scrubbing and sorting S11.

After the final lead file has been created S15, this file may be sent to a vendor. The vendor receives the final lead file and may contact the people on the list and offer them the dual ER/Savings account with or without the ERP feature S18. A person at a customer site may receive dual ER/savings account offers, S19, and determine if the person would like to purchase the dual ER/savings account S20. If the person does not desire the dual ER/savings account, the process ends S21. However, if the person decides to purchase the dual ER/savings account, the vendor is notified via receipt of an application from the person. The vendor captures the application and determines whether the ERP feature is also desired and submits the application to the financial institution for evaluation S22. The application information may be stored in a sales disposition file at the financial application S23. Further, the information may be sent to a credit bureau vendor that evaluates if the applicant (person) still qualifies for the dual ER/savings account S30. A result of this application evaluation may be sent to the financial institution and stored S32.

A list processing vendor may also receive the final lead file from the financial institution and create and mail offers to the final leads S24. A person at the customer site may receive the mail offer S25 and determine if they want to apply S26 and if not the process ends S27. If the person decides to apply for the dual ER/savings account, the person may apply by mail or phone S28. A vendor may then input the application from the person and determine whether the ERP feature is also desired and submit the application for evaluation to a credit bureau or credit verification vendor S29. The credit bureau may evaluate if the applicant still qualifies S30 and send this evaluation to the financial institution that may store the application evaluation outcome S32. The credit bureau vendor then may determine if the application is approved S33. If the application is not approved, a decline letter may be generated and sent to the person S36. The person may receive the decline letter S37 and the process ends. If the application is approved, this application and other approved applications may be forwarded to the financial institution for fulfillment and account set up S34. The response vendor, after inputting the application S29, may send the application to the financial institution for storage S31.

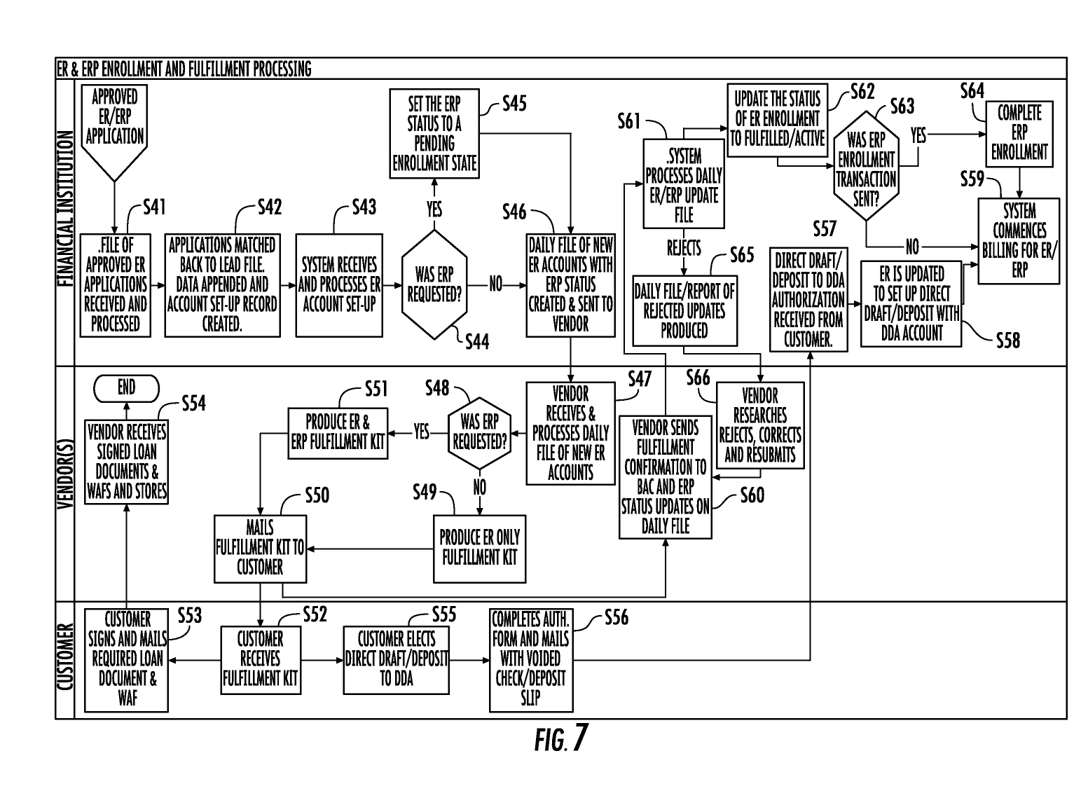

FIG. 7 shows a flowchart of a dual ER/savings account enrollment and fulfillment process according to an example embodiment of the present invention. The approved dual ER/savings account application file is received and processed at the financial institution S41. The financial institution may receive several of these applications and process them simultaneously. The applications may be matched back to the lead file, data appended to the applications, and an account setup record created S42. The dual ER/savings account applications are processed and accounts setup S43, and it is determined whether the ERP feature was requested S44. If the ERP feature was requested, an ERP status may be set to a pending enrollment state S45. The financial institution may also create a daily file of new dual ER/savings accounts with ERP status and send it to a processing vendor S46.

The processing vendor receives and processes the received daily file of new dual ER/savings accounts S47, and determines whether the ERP feature was requested S48. If the ERP feature was not requested, only a dual ER/savings account fulfillment kit is produced S49, and the kit mailed to the person S50. If the ERP feature was requested, a dual ER/savings account and ERP fulfillment kit may be prepared S51, and mailed to the person S50.

At the customer site, the person receives the fulfillment kit S52, signs and mails the required credit documents to the processing vendor S53. The processing vendor then receives the signed credit documents and stores this information S54. The person may also elect direct draft/deposit to his direct deposit account S55, and complete an authorization form and send this form with appropriate other documentation (e.g., voided check/deposit slip) to the financial institution S56. The financial institution receives the direct draft/deposit to direct deposit account authorization from the customer S57, and updates the dual ER/savings account to set up direct draft/deposit with the direct deposit account S58. Billing then commences for the dual ER/savings account and ERP S59.

After mailing the fulfillment kit to the person S50, the processing vendor may then send fulfillment confirmation and ERP status updates on a daily file to the financial institution S60. The financial institution may process the daily dual ER/savings account update file S61. The financial institution may generate a daily file/report of rejected updates S65 and forward these to the processing vendor. The processing vendor may then research the rejects make any appropriate corrections and resubmit these to the financial institution S66. After processing the daily dual ER/savings account update file S61, the financial institution may update the status of the dual ER/savings account enrollment to fulfilled/active S62. The financial institution may then determine whether an ERP enrollment transaction was sent S63 and, if so, the ERP enrollment is completed S64. Dual ER/savings account billing may then commence S59. If the financial institution determines that the ERP enrollment transaction was not sent S63, then the billing for the ERP may commence S59.

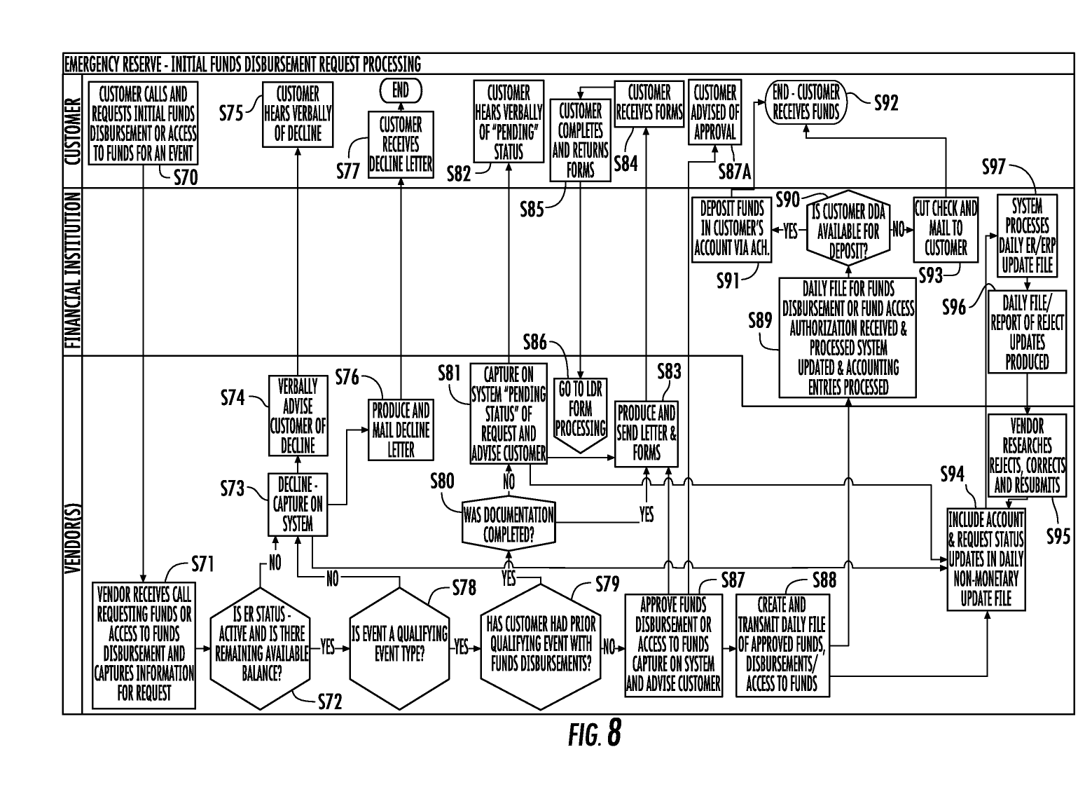

FIG. 8 shows a flowchart of an emergency reserve initial funds disbursement request process for a dual ER/savings Account according to an example embodiment of the present invention. A customer may call and request an initial funds disbursement (if the ER portion of the dual ER/savings account is configured as a loan) or access to finds (if the ER portion of the dual ER/savings account is configured as a line-of-credit) based on occurrence of a covered event S70. A processing vendor may receive the call requesting the funds disbursement or access to the funds and capture required information for the request S71. The processing vendor may then determine the amount in the savings account portion of the dual ER/Savings account, if the ER status is active and/or if there is any remaining balance to draw from S72. The savings account portion will be looked to first to satisfy the emergency reserve needs of the customer and, once the savings account is fully depleted of funds, the ER feature of the dual ER/Savings account will be relied on to provide the balance of the emergency reserve needs. For example, if at the time of the covered event the customer has $3000 in the savings account portion of the dual ER/Savings account the customer will draw from the $3000 in the savings account and, once those funds are depleted and if the covered event still exists, the customer will be provided access to the ER funds.

Once the customer has depleted the funds in the savings account portion of the dual ER/Savings account, if the ER status is not active or there is no remaining balance, the request may be declined S73 and the customer advised of the decline decision S74. The customer may hear verbally or via other methods of the decline of the request S75.

If the ER status is active (i.e., fee payment is current) and there is a remaining balance, the processing vendor may determine whether the event is a qualifying event type S78, and if not, the request is denied/declined S73 as noted previously. Alternatively the vendor may produce and mail an advisory letter to the client S76, and the customer receives the decline letter S77. If the event is a qualifying event, the processing vendor may then determine if the customer has had a prior qualifying event with fund disbursements S79. If the customer has had a prior qualifying event with funds disbursements, the processing vendor may determine whether documentation was completed S80, and if not, set a system pending status on the request and advise the customer S81. The customer may then be notified verbally of the pending status S82. Further, the processing vendor may also produce and send letters and forms related to the pending status to the customer S83. Similarly, if the documentation was completed, the processing vendor may produce and send letters and/or forms to the customer S83. The customer receives the forms S84, and completes and may return the forms to a processing center of the vendor S85 for credit disbursement form processing.

After the pending status is set for the request and the customer advised by the processing vendor S81, account and request status updates may be included in a daily non-monetary update file S94. Further, if it is determined that the customer did not have a qualifying event with funds disbursements, the funds disbursement or access to the funds may be approved S87 and the customer advised accordingly S87A. A daily file of approved funds disbursements or approved access to funds may be created and transmitted S88 by a processing vendor to the financial institution and account/request status updates included in the daily non-monetary update file S94. The financial institution may receive and process the daily file for funds disbursement or fund access authorization, and updates and processes accounting entries S89.

In the loan ER scenario, the financial institution may then determine if the customer has direct deposit account (DDA) available for deposit S90 and, if not, may cut a check and mail the check to the customer S93 where the customer then receives the funds via check S92. If a direct deposit account is available, the funds may be deposited into the customer's direct deposit account S91 where the customer then has access to the funds S92.

After the account and request status updates have been included in the daily non-monetary update file S94, a daily dual ER/savings account update file may be processed S97. A daily file/report of reject updates may be produced S96, and sent to the processing vendor. The processing vendor may then research the rejects, make any appropriate corrections and resubmit S95 where the account and request status updates are included again in the daily non-monetary update file S94.

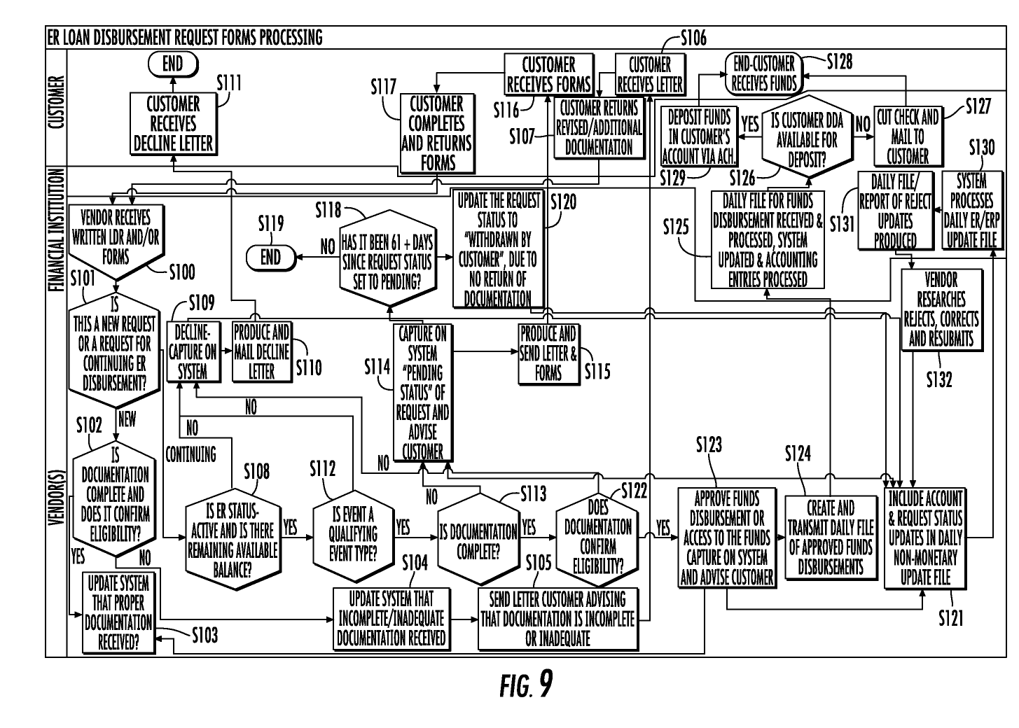

FIG. 9 shows a flowchart for a continuing ER credit disbursement forms evaluation process used in conjunction with a dual ER/savings account, according to an example embodiment of the present invention. A processing vendor receives written (or electronic) benefit request and/or documentation forms S100. The processing vendor determines if this is a new request or a request for continuing ER benefit S101. If this is a new request, the processing vendor determines whether documentation is complete and does the documentation confirm eligibility S102. If the documentation is complete, the system is updated that proper documentation has been received S103. If the documentation is not complete, the system is updated that incomplete/inadequate documentation has been received S104, and the customer is notified and advised that the documentation is incomplete or inadequate S105. The customer receives the notification, S106, and may return the revised/additional documentation to the processing vendor S107.

If it is determined that this is a continuing ER benefit, S101, the processing vendor may determine if the ER status is active and if there is a remaining balance to draw S108. If the ER status is not active or there is no remaining balance, the request is declined S109, and a client letter saying the same may be prepared and mailed or electronically transferred to the customer S110. The customer receives the decline letter and the process ends S111.

If the ER status is active and there is a remaining balance, the processing vendor determines whether the event is a qualifying event type S112, and if not, again the request is declined S109, and a letter sent to the customer S110. However, if the event is a qualifying event, the processing vendor determines whether the documentation is complete S113. If the documentation is not complete, a pending status is captured on the system regarding the request S114, and a letter and appropriate forms produced S115, and transferred to the customer. The customer receives the forms S116, completes and returns the forms S117, and the processing vendor receives the completed documentation forms S100 and the process resumes. Further, after the pending status has been captured on the system S114, the processing vendor determines if a certain amount of days have passed since the request status has been set to “pending” S118, and if not, this part of the process ends S119. If the certain amount of time since the status has been set to “pending” has occurred, the processing vendor may update the request status to “withdrawn by customer due to no return of documentation” S120, and include account and request status updates in the daily non-monetary update file S121.

If it is determined that the documentation is complete S113, the processing vendor determines does the documentation confirm eligibility S122. If the documentation does not confirm eligibility, the request may be declined S109, and the customer notified. If the documentation does confirm eligibility, the funds disbursement or access to the funds may be approved and the approval captured on the system S123. A daily file of approved funds disbursements may be created and transmitted to the financial institution S124. This daily file is received and processed by the financial institution S125.

In the loan ER scenario, the financial institution may then determine if the customer has a direct deposit account available for deposit S126, and if not, cut a check and mail the check to the customer S127. If a direct deposit account is available, the funds are deposited into the customer's direct deposit account S129. The customer may then receive the funds either from the received check or from funds in the direct deposit account S128.

After the approval of funds S123, the processing vendor may include the account and request status updates in the daily non-monetary update file S121. The financial institution may receive and process the daily dual ER/savings account updates file S130, produce a daily file/report of rejected updates S131, and transmit this to the processing vendor. The processing vendor receives the daily file/report, researches, rejects, and makes any appropriate corrections, and resubmits S132. The processing vendor then includes account and request status updates in the daily non-monetary update file S121.

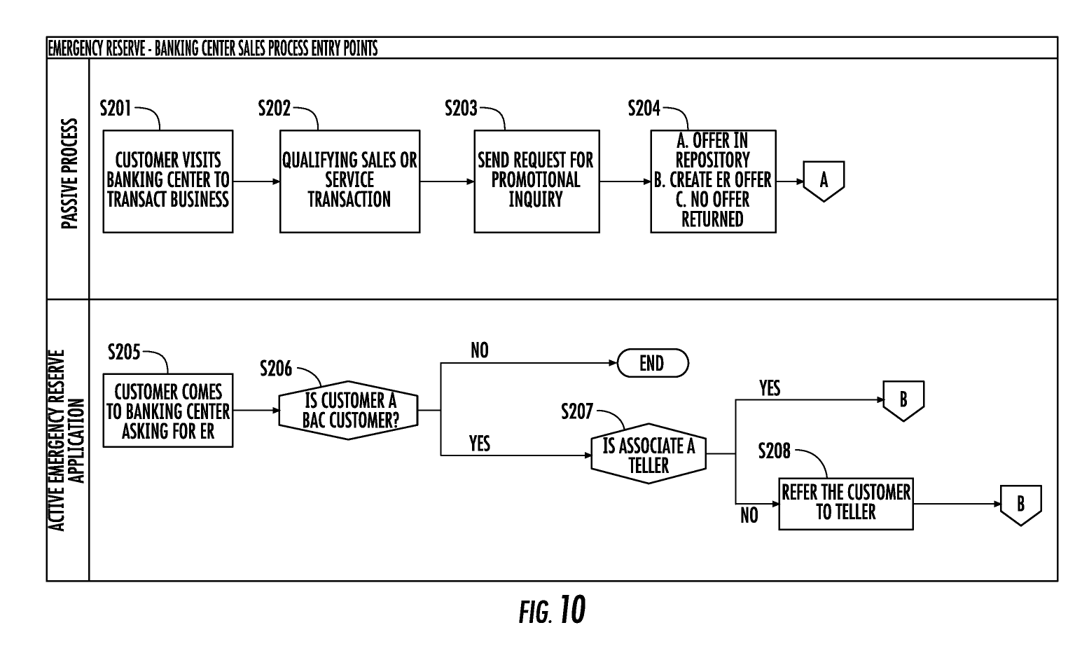

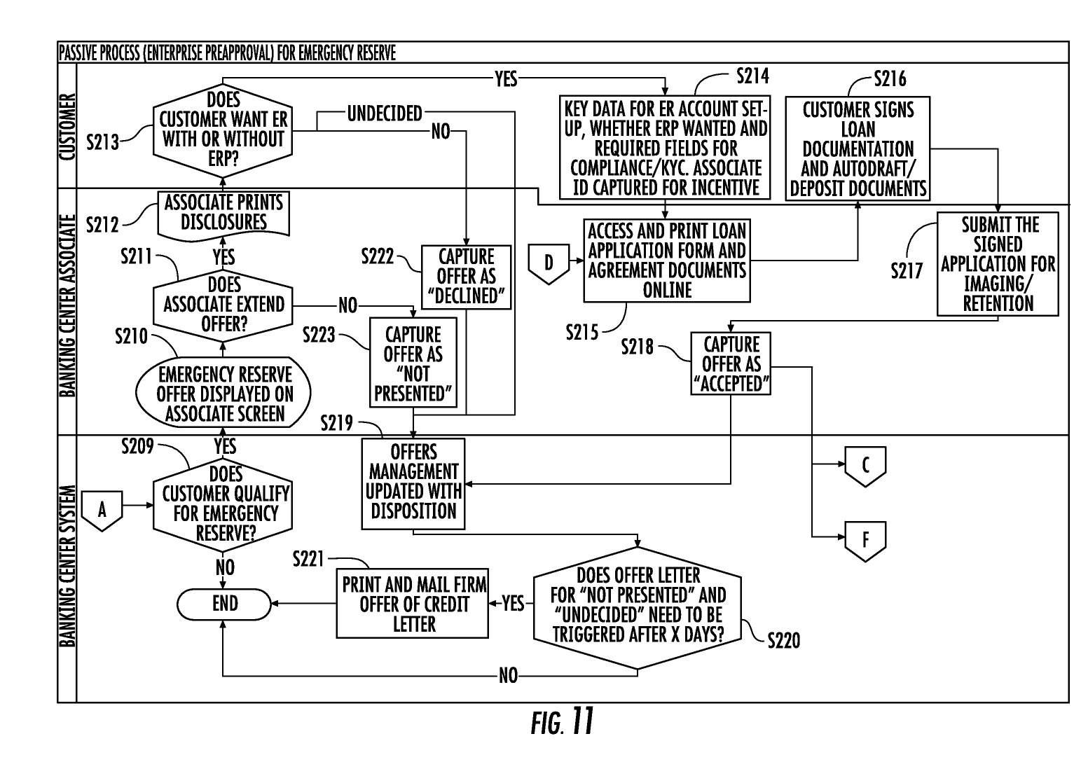

FIG. 10 shows a flowchart of a process for processing a dual ER/savings account at a banking center according to an example embodiment of the present invention. This process may include a passive process and an active dual ER/savings account activation process. In the passive process, a person visits a banking center to transact business, S201. The person performs qualifying sales or a service transaction, S202. A request may be sent for promotional inquiry, S203. Then, (a) an offer is in a repository, (b) a dual ER/Savings account offer, that may include emergency reserve protection, is created or (c) no offer is returned, S204. This process then proceeds to block S209 in FIG. 11.

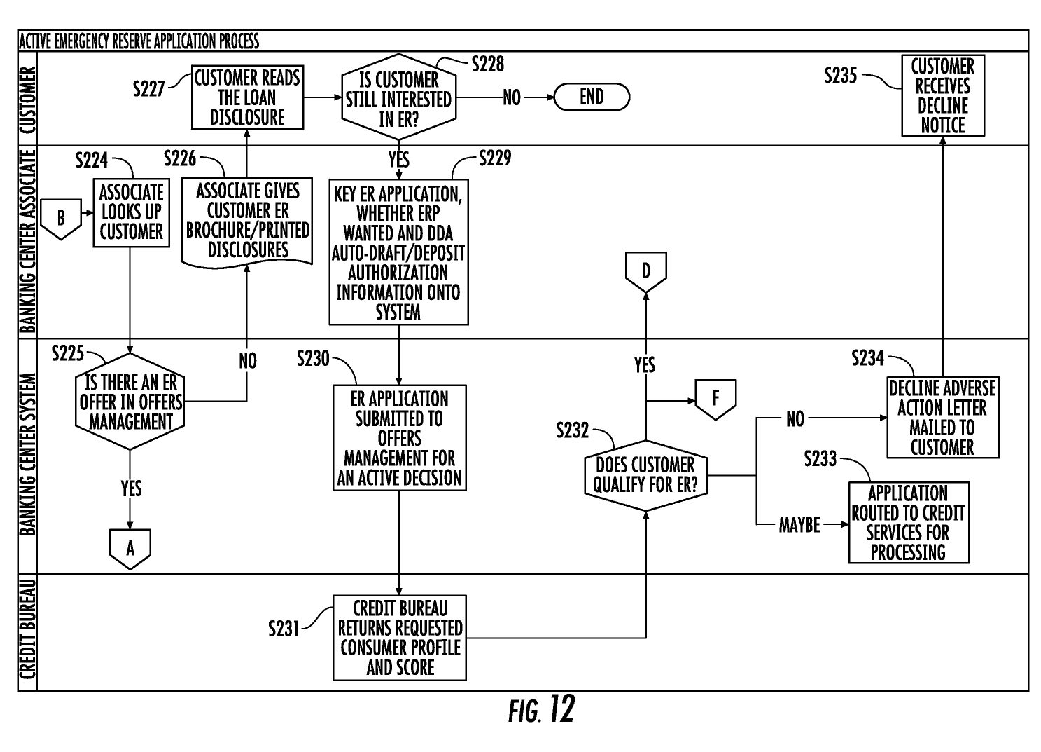

In the active dual ER/savings account application process, a person comes to the banking center asking for a dual ER/Savings account, S205. It may be determined whether the person is a banking center customer, S206, and if not the process ends. If the person is a banking center customer, it may be determined if an associate helping the person is a teller, S207, and if not, the person may be referred to a teller, S208. The process then proceeds in either case to block S224 in FIG. 12.

FIG. 11 shows a flowchart of an enterprise pre-approval portion of the passive process of FIG. 10 according to an example embodiment of the present invention. It may be determined whether the person qualifies for a dual ER/savings account, S209, and if not, the process ends. If the person qualifies for a dual ER/savings account, a dual emergency reserve/savings account offer may be displayed on an associates screen, S210. It may be determined if the associate has extended an offer, S211, and if not, the offer may be captured as “not presented,” S223. Offers Management may be updated with the disposition, S219. Then, it may be determined whether an offer letter for “not presented” and “undecided” needs to be triggered after a certain number of days, S220, and if not, the process ends. If it is determined that an offer letter needs to be triggered, a firm offer of credit letter may be printed and mailed, S221, and the process ends. If the associate does extend an offer, S211, the associate may print the disclosures, S212. Then, it may be determined whether the person wants the emergency reserve, S213, and if not, the offer may be captured as “declined,” S222, Offers Management updated with disposition, S219, and the determination of whether an offer letter should be triggered, S220, and printed and mailed, S221, may occur as previously discussed.

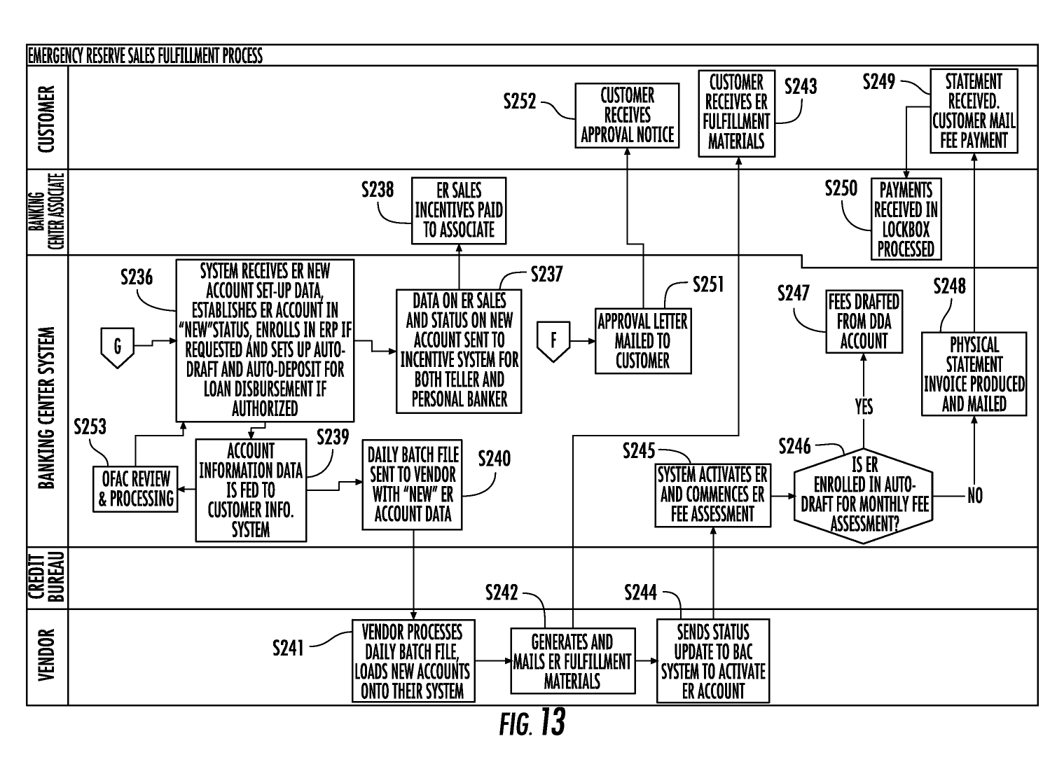

If the person is undecided regarding wanting the dual ER/savings account, Offers Management may be updated with the disposition S219 and the determination of whether an offer letter is triggered, S220, and printing and mailing of an offer of credit letter, S221, may occur as previously mentioned. If the person does want the dual ER/savings account, with or without Emergency Reserve Protection, S213, data may be keyed for an emergency reserve account set up and required fields for compliance/KYC. The associate ID may be captured for an associate incentive, S214. The credit application form and agreement documents may be accessed on-line and printed, S215. The customer may sign the credit documentation and auto-draft/deposit documents, S216. The signed application may be submitted for imaging/retention, S217, the offer captured as “accepted,” S218, and the process proceed to blocks S236 and S251 in FIG. 13.

FIG. 12 shows a flowchart of a further portion of the active dual ER/savings account application process of FIG. 10 according to an example embodiment of the present invention. An associate may look up a person, S224. It may be determined whether there is a dual ER/savings account offer in Offers Management, S225, and if so, the process continues to block S209 in FIG. 11. If there is no offer in Offers Management, an associate may give the person dual ER/savings account brochures and other printed disclosures, S226. The person reads the credit disclosures, S227. It may be determined whether the person is still interested in a dual ER/savings account S228, and if not, the process ends. If the person is interested in a dual ER/savings account, a dual ER/savings account application and direct deposit account (DDA) auto-draft/deposit authorization information may be keyed into the system, S229. The dual ER/savings account application may be submitted to Offers Management for an active decision, S230. A credit bureau may return a requested consumer profile and score, S231. It may be determined whether the person qualifies for the dual ER/savings account, S232, and if so, the process proceeds to block S215 in FIG. 11 and block S251 in FIG. 13. If the person might qualify for dual ER/savings account, the application may be routed to credit services for processing, S233. If the person does not qualify for dual ER/savings account, a decline adverse action letter may be mailed to the person, S234, and the person may receive the decline notice, S235.

FIG. 13 shows a flowchart of a dual ER/savings account sales fulfillment process according to an example embodiment of the present invention. This process is a part of the passive process and active dual ER/savings account activation process mentioned previously. A banking center system may receive the dual ER/savings account new account set up data with or without emergency reserve protection, establish a dual ER/savings account in “new” status and set up auto-draft and auto-deposit for credit disbursement if authorized, S236. Account information data may be fed to the customer information system, S239. Review and processing may occur, S253. After the system receives the emergency reserve new account set up data, S236, the data on dual ER/savings account sales and status on new account may be sent to an incentive system for both teller and personal banker, S237, and dual ER/savings account sales incentives paid to the associate, S238.

After the account information data is fed to the customer information system, S239, a daily batch file may be sent to a vendor with “new” dual ER/savings account data, S240. The vendor may process the daily batch file, and load new accounts onto their system, S241. The vendor may generate and mail dual ER/savings account fulfillment materials, S242. The person receives the dual ER/savings account fulfillment materials, S243. An approval letter may be mailed to a person, S251, and the person receives the approval notice, S252. After the vendor generates and mails the dual ER/savings account fulfillment materials, S242, the vendor may send a status update to the banking system to activate the dual ER/savings account, S244. The system may activate the dual ER/savings account and commence emergency reserve fee assessment, S245. It may be determined whether the dual ER/savings account is enrolled in auto-draft for periodic emergency reserve fee assessment, S246, and if so, fees may be drafted from a direct debit account, S247. If the dual ER/savings account is not enrolled in an auto-draft, a physical statement invoice may be produced and mailed, S248, the statement is received by a customer and the customer mails the fee payment, S249, and the payments are received in a lockbox by a banking center associate and processed accordingly, S250.

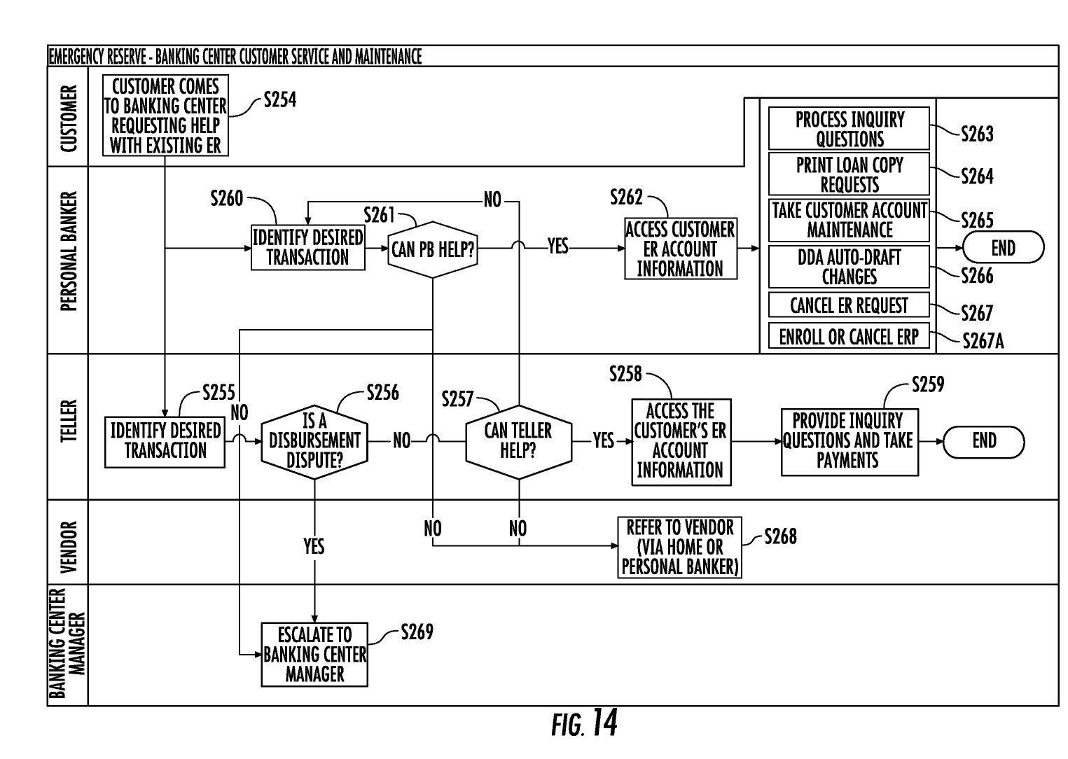

FIG. 14 shows a flowchart of a dual ER/savings account banking center and maintenance process according to an example embodiment of the present invention. A customer comes to a banking center requesting help with an existing dual ER/savings account, S254. A personal banker may identify a desired transaction, S260, and determine whether the personal banker can help, S261. If the personal banker cannot help, the customer may be referred to a vendor, S268, or may escalate to a banking center manager, S269. If the personal banker can help, the customer dual ER/savings account information may be accessed by the personal banker, S262, the personal banker may then process inquiry questions, S263, print credit copy requests, S264, take customer account maintenance, S265, make direct deposit account auto-draft changes, S266, cancel a request, S267 or enroll or cancel emergency reserve protection S267A, and then the process ends.

Moreover, after the customer comes to the banking center requesting help, S254, a teller may identify the desired transaction, S255, and determine whether it is a disbursement dispute, S256. If it is a disbursement dispute, the matter may escalate to a banking center manager, S269. If it is not a disbursement dispute, it may be determined whether the teller can help, S257, and if not, the customer may be referred to a vendor, S268, or a personal banker. If it is determined that the teller can help, the teller may access the customer's dual ER/savings account information, S258, provide inquiry questions and take payments, S259, and the process ends.

System and method embodiments according to the present invention are advantageous for several reasons. For example, people having lesser credit worthiness are able to obtain credit when these people may not typically qualify for credit. Further, the use of actuary information provides a lower risk to financial institutions in offering these conditional credit products. Further, since the dual ER/savings account and ERP feature are bank products, they may be sold by bank personnel as contrasted to insurance products that can only be sold by licensed personnel. Moreover, by offering these type products to current financial institution customers, the attrition of existing customers is minimized since without these products these customers may need to close their accounts to survive. Further, the dual ER/savings account and ERP feature are versatile in that the initial cash amount or the initial amount accessible may be varied as well as the maximum payout amount. In this regard, the cost on a periodic fee basis to a customer may vary accordingly depending on these amounts.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for establishing a dual emergency reserve/savings account and allocating deposits to a dual emergency reserve/savings account, the method comprising:
determining a customer's emergency reserve amount based on the customer's perceived financial needs during occurrence of a predetermined covered event;
establishing, for the customer, a dual emergency reserve/savings account that includes a savings account and an emergency reserve feature, wherein the emergency reserve feature is for the determined customer's emergency reserve amount;
receiving a deposit amount for the dual emergency reserve/savings account;
determining, via computing device processor, for the deposit amount, a savings amount allocation and an emergency reserve fee allocation; and
depositing, via a computing device processor, the savings amount in the savings account of the dual emergency reserve/savings account and applying the emergency reserve fee to the emergency reserve feature.

2. The method of claim 1, wherein determining the customer's emergency reserve amount further comprises determining, via a computing device processor, the customer's emergency reserve amount based on one of a plurality of customer models associated with the customer's current financial needs.

3. The method of claim 1, wherein determining the customer's emergency reserve amount further comprises determining, via a computing device processor, the customer's emergency reserve amount based on customer inputs to a plurality of financial needs queries.

4. The method of claim 1, wherein establishing further comprises establishing, for the customer, the dual emergency reserve/savings account that includes the emergency reserve feature, wherein an initial emergency reserve fee associated with the emergency reserve feature is based on the customer's emergency reserve amount.

5. The method of claim 1, wherein establishing further comprises establishing, for the customer, the dual emergency reserve/savings account including the emergency reserve feature, wherein the emergency reserve feature is available to the customer in a form of a line-of-credit.

6. The method of claim 1, wherein establishing further comprises establishing, for the customer, the dual emergency reserve/savings account including the emergency reserve feature, wherein the emergency reserve feature is available to the customer in a form of a loan.

7. The method of claim 1, further comprising determining the deposit amount based on the customer's current financial needs prior to receiving the deposit amount.

8. The method of claim 7, wherein determining the deposit amount further comprises determining, via computing device processor, the deposit amount based on one of a plurality of customer models associated with the customer's current financial need.

9. The method of claim 7, wherein determining the deposit amount further comprises determining, via a computing device processor, the deposit amount based on customer inputs to a plurality of financial needs queries.

10. The method of claim 1, wherein determining, for the deposit amount, a savings amount allocation and an emergency reserve fee allocation further comprises calibrating, via the computing device processor, the savings amount allocation and the emergency reserve fee allocation based on a current savings amount balance in the dual emergency reserve/savings account.

11. The method of claim 10, wherein calibrating further comprises decreasing the emergency reserve fee allocation based on an increase in the savings amount balance.

12. The method of claim 1, wherein depositing the savings amount further comprises depositing, via the computing device processor, the deposit amount in the savings account once a current savings amount balance meets the customer's emergency reserve amount.

13. The method of claim 1, further comprising receiving, from the customer, a covered event indication that indicates an occurrence of one of a plurality of covered events.

14. The method of claim 13, further comprising providing the customer with a predetermined amount of funds from the emergency reserve feature or access to a predetermined amount of funds from the emergency reserve feature for a predetermined interval.

15. The method of claim 14, wherein providing the customer further comprises providing the customer with the predetermined amount of funds from the emergency reserve feature or access to the predetermined amount of funds from the emergency reserve feature for a predetermined interval based on verifying of the occurrence of the covered event.

16. The method of claim 14 wherein providing the customer further comprises providing the customer with the predetermined amount of funds from the emergency reserve feature or access to the predetermined amount of funds from the emergency reserve feature for a predetermined interval based on verifying a validity of the emergency reserve feature.

17. The method of claim 16, wherein verifying the validity of the emergency reserve feature further comprises verifying that emergency reserve fee payment is current and verifying that funds currently exist in the emergency reserve feature.

18. An apparatus for providing dual emergency reserve/savings accounts and allocating deposits to the accounts, the apparatus comprising:
a computing platform including a memory and a processor in communication with the memory;
a dual emergency reserve/savings account module stored in the memory, executable by the processor and including:
an emergency reserve amount-determining routine configured to determine a customer's emergency reserve amount based on the customer's perceived financial needs during occurrence of a predetermined covered event;
a dual emergency reserve/savings establishment application configured to establish for the customer, and store in a database, a dual emergency reserve/savings account that includes a savings account and an emergency reserve feature, wherein the emergency reserve feature is for the determined customer's emergency reserve amount;
a deposit allocation routine configured to receive a deposit amount for the dual emergency reserve/savings account, determine for the deposit amount a savings amount allocation and an emergency reserve fee allocation and deposit the savings amount in the savings account and applying the emergency reserve fee to the emergency reserve feature.

19. The apparatus of claim 18, wherein the emergency reserve amount-determining routine is further configured to determine the customer's emergency reserve amount based on one of a plurality of customer models associated with the customer's current financial needs.

20. The apparatus of claim 18, wherein emergency reserve amount-determining routine is further configured to determine the customer's emergency reserve amount based on customer inputs to a plurality of financial needs queries.

21. The apparatus of claim 18, wherein the dual emergency reserve/savings establishment application is further configured to establish the dual emergency reserve/savings account that includes the emergency reserve feature, wherein an initial emergency reserve fee associated with the emergency reserve feature is based on the customer's emergency reserve amount.

22. The apparatus of claim 18, wherein the dual emergency reserve/savings establishment application is further configured to establish the dual emergency reserve/savings account including the emergency reserve feature, wherein the emergency reserve feature is available to the customer in a form of a line-of-credit.

23. The apparatus of claim 18, wherein the dual emergency reserve/savings establishment application is further configured to establish the dual emergency reserve/savings account including the emergency reserve feature, wherein the emergency reserve feature is available to the customer in a form of a loan.

24. The apparatus of claim 18, wherein the dual emergency reserve/savings account module further comprises a deposit amount-determining routine configured to determine the deposit amount based on the customer's current financial needs prior to receiving the deposit amount.

25. The apparatus of claim 24, wherein the deposit amount-determining routine is further configured to determine the deposit amount based on one of a plurality of customer models associated with the customer's current financial need.

26. The apparatus of claim 24, wherein the deposit amount-determining routine is further configured to determine the deposit amount based on customer inputs to a plurality of financial needs queries.

27. The apparatus of claim 18, wherein the deposit allocation routine is further configured to calibrate the savings amount allocation and the emergency reserve fee allocation based on a current savings amount balance in the dual emergency reserve/savings account.

28. The apparatus of claim 27, wherein the deposit allocation routine is further configured to decrease the emergency reserve fee allocation based on an increase in the savings amount balance.

29. The apparatus of claim 18, wherein the deposit allocation routine is further configured to deposit the deposit amount in the savings account once a current savings amount balance meets the customer's emergency reserve amount.

30. The apparatus of claim 18, wherein the dual emergency reserve/savings account module further comprises an emergency reserve fund distribution routine configured to receive, from the customer, a covered event indication that indicates an occurrence of one of a plurality of covered events and provide the customer with a predetermined amount of funds from the emergency reserve feature or access to a predetermined amount of funds from the emergency reserve feature for a predetermined interval.

31. The apparatus of claim 30, wherein the emergency reserve distribution routine is further configured to provide the customer with the predetermined amount of funds from the emergency reserve feature or access to the predetermined amount of funds from the emergency reserve feature for a predetermined interval based on verifying of the occurrence of the covered event.

32. The apparatus of claim 30, wherein the emergency reserve distribution routine is further configured to provide the customer with the predetermined amount of funds from the emergency reserve feature or access to the predetermined amount of funds from the emergency reserve feature for a predetermined interval based on verifying a validity of the emergency reserve feature.

33. The apparatus of claim 32, wherein the emergency reserve distribution routine is further configured to verify the validity of the emergency reserve feature by verifying that emergency reserve fee payment is current and verifying that funds currently exist in the emergency reserve feature.

34. A computer program product comprising:
a non-transitory computer-readable medium comprising:
a first set of codes for causing a computer to determine a customer's emergency reserve amount based on the customer's perceived financial needs during occurrence of a predetermined covered event;
a second set of codes for causing a computer to establish, for the customer, a dual emergency reserve/savings account that includes a savings account and an emergency reserve feature, wherein the emergency reserve feature is for the determined customer's emergency reserve amount;
a third set of codes for causing a computer to determine, for a received deposit amount, a savings amount allocation and an emergency reserve fee allocation; and
a fourth set of codes for causing a computer to deposit the savings amount in the savings account of the dual emergency reserve/savings account and apply the emergency reserve fee to the emergency reserve feature.

35. The computer program product of claim 34, wherein the first set of codes is further configured to cause the computer to determine the customer's emergency reserve amount based on one of a plurality of customer models associated with the customer's current financial needs.

36. The computer program product of claim 34, wherein the first set of codes is further configured to cause the computer to determine the customer's emergency reserve amount based on customer inputs to a plurality of financial needs queries.

37. The computer program product of claim 34, wherein the second set of codes is further configured to cause the computer to establish the dual emergency reserve/savings account that includes the emergency reserve feature, wherein an initial emergency reserve fee associated with the emergency reserve feature is based on the customer's emergency reserve amount.

38. The computer program product of claim 34, wherein the second set of codes is further configured to cause the computer to establish the dual emergency reserve/savings account including the emergency reserve feature, wherein the emergency reserve feature is available to the customer in a form of a line-of-credit.

39. The computer program product of claim 34, wherein the second set of codes is further configured to cause the computer to establish the dual emergency reserve/savings account including the emergency reserve feature, wherein the emergency reserve feature is available to the customer in a form of a loan.

40. The computer program product of claim 34, further comprising a fifth set of codes for causing a computer to determine the deposit amount based on the customer's current financial needs prior to receiving the deposit amount.

41. The computer program product of claim 40, wherein the fifth set of codes is further configured to cause the computer to determine the deposit amount based on one of a plurality of customer models associated with the customer's current financial need.

42. The computer program product of claim 40, wherein the fifth set of codes is further configured to cause the computer to determine the deposit amount based on customer inputs to a plurality of financial needs queries.

43. The computer program product of claim 34, wherein the third set of codes is further configured to cause the computer to calibrate the savings amount allocation and the emergency reserve fee allocation based on a current savings amount balance in the dual emergency reserve/savings account.

44. The computer program product of claim 43, wherein the third set of codes is further configured to cause the computer to decrease the emergency reserve fee allocation based on an increase in the savings amount balance.

45. The computer program product of claim 34, wherein the fourth set of codes is further configured to cause the computer to deposit the deposit amount in the savings account once a current savings amount balance meets the customer's emergency reserve amount.

46. The computer program product of claim 34, further comprising a fifth set of codes for causing a computer to receive, from the customer, a covered event indication that indicates an occurrence of one of a plurality of covered events.

47. The computer program product of claim 46, further comprising a sixth set of codes for causing a computer to provide the customer with a predetermined amount of funds from the emergency reserve feature or access to a predetermined amount of funds from the emergency reserve feature for a predetermined interval.

48. The computer program product of claim 47, wherein the sixth set of codes is further configured to cause the computer to provide the customer with the predetermined amount of funds from the emergency reserve feature or access to the predetermined amount of funds from the emergency reserve feature for a predetermined interval based on verifying of the occurrence of the covered event.

49. The computer program product of claim 47 wherein the sixth set of codes is further configured to cause the computer to provide the customer with the predetermined amount of funds from the emergency reserve feature or access to the predetermined amount of funds from the emergency reserve feature for a predetermined interval based on verifying a validity of the emergency reserve feature.

50. The computer program product of claim 49, wherein the sixth set of codes is further configured to cause the computer to verify that emergency reserve fee payment is current and verify that funds currently exist in the emergency reserve feature.

51. A method for allocating deposits to a dual emergency reserve/savings account, the method comprising:
receiving a deposit amount for a dual emergency reserve/savings account;
determining, via computing device processor, for the deposit amount, a savings amount allocation and an emergency reserve fee allocation; and
depositing, via a computing device processor, the savings amount in the savings account of the dual emergency reserve/savings account and applying the emergency reserve fee to the emergency reserve feature.

52. The method of claim 51, wherein determining, for the deposit amount, a savings amount allocation and an emergency reserve fee allocation further comprises calibrating, via the computing device processor, the savings amount allocation and the emergency reserve fee allocation based on a current savings amount balance in the dual emergency reserve/savings account.

53. The method of claim 52, wherein calibrating further comprises decreasing the emergency reserve fee allocation based on an increase in the savings amount balance.

54. The method of claim 51, wherein depositing the savings amount further comprises depositing, via the computing device processor, the deposit amount in the savings account once a current savings amount balance meets the customer's emergency reserve amount.

55. An apparatus for providing dual emergency reserve/savings accounts and allocating deposits to the accounts, the apparatus comprising:
a computing platform including a memory and a processor in communication with the memory;
a dual emergency reserve/savings account module stored in the memory, executable by the processor and including:
a deposit allocation routine configured to receive a deposit amount for the dual emergency reserve/savings account, determine for the deposit amount a savings amount allocation and an emergency reserve fee allocation and deposit the savings amount in the savings account and applying the emergency reserve fee to the emergency reserve feature.

56. The apparatus of claim 55, wherein the deposit allocation routine is further configured to calibrate the savings amount allocation and the emergency reserve fee allocation based on a current savings amount balance in the dual emergency reserve/savings account.

57. The apparatus of claim 56, wherein the deposit allocation routine is further configured to decrease the emergency reserve fee allocation based on an increase in the savings amount balance.

58. The apparatus of claim 55, wherein the deposit allocation routine is further configured to deposit the deposit amount in the savings account once a current savings amount balance meets the customer's emergency reserve amount.
